(19) United States
(12) Patent Application Publication
(10) Pub. No.: US 2006/0133908 A1
(43) Pub. Date: Jun. 22, 2006

(54) Anchor element

(76) Inventors: Jakob Kunz, Grabs (CH); Falk Rosenkranz, Rauleweil-Brederis (AT); Balz Gfeller, Biel (CH); Frederic Pichelin, Saeriswil (CH); Mario Lehmann, Les Pommerats (CH); Rene Graf, Yverdon-les-Bains (CH)

Correspondence Address: ABELMAN, FRAYNE & SCHWAB, 666 THIRD AVENUE, 10TH FLOOR, NEW YORK, NY, 10017, US

(21) Appl. No.: 11/290,901

(22) Filed: Nov. 29, 2005

(30) Foreign Application Priority Data
Nov. 30, 2004 (DE) 10 2004 057 710.2

(51) Int. Cl. F16B 13/04

(52) U.S. Cl. 411/21

(57) ABSTRACT

An anchor element (11) has an anchor part (12), a sleeve part (13), and an expansion part (18) for expanding the sleeve part (13). The sleeve part (13) is secured to the anchor part (12) and is made of a thermoplastic.

### BACKGROUND OF THE INVENTION

1. Field of the Invention

The present invention relates to an anchor element having anchor part, a sleeve part surrounding the anchor part, and an expansion part for expanding the sleeve part.

2. Description of the Prior Art

Installations, e.g., in electrical and sanitation fields, and ceiling fixtures are fastened to substrates, e.g., walls and ceilings of a building, by anchor elements that are anchored in bores. For instance, screw anchors in the form of thread-cutting concrete screws which are screwed into a previously prepared bore are used for fastening in mineral substrates such as concrete or masonry. Screws are likewise used in organic substrates such as wood. The known solutions are disadvantageous in that a considerable expenditure of force is required for setting a screw anchor and the surrounding building material is damaged. Anchor elements, as they are called, are known for overcoming these disadvantages.

DE 41 16 149 A1 discloses anchor elements in the form of expansion dowels having an anchor part with a sleeve part. An expansion part is formed at the anchor part, this expansion part expands the sleeve part under tension, and an undercut is accordingly produced in the bore hole.

This known solution is disadvantageous in that these anchor elements introduce loads locally, at least in the region of the base of the bore, so that high stresses occur in this region leading to a sharply reduced carrying capacity in the set anchor element when the edge distances or axial distances of the anchor elements are small. Further, an annular gap remains between the anchor element and the wall of the bore hole and water or moisture can penetrate therein and can cause corrosion particularly in metal anchor parts.

On the other hand, there are known chemical anchor elements in which an anchor part is fastened in the bore with composite mortar. For example, the composite mortar is injected from an applicator into the bore in the substrate and an anchor part, e.g., a threaded rod, is then inserted. Further, DE 197 04 002 A1, for example, discloses an anchor part for anchoring in a composite mortar, wherein the composite mortar is enclosed, e.g., in a cartridge made of glass or in a bag made of plastic and is inserted into the bore hole in this form along with the packaging. The anchor part is driven into the bore by rotating movements and impacting movements, the packaging of the composite mortar is destroyed, and the composite mortar system is mixed together. In the chemical anchor elements, the load is introduced so as to be distributed over the entire length of the bore hole wall.

This known solution is disadvantageous in that the anchor element cannot be loaded after setting until the composite mortar has hardened, which can take from 1 hour to 24 hours depending on the circumstances such as the temperature of the substrate or of the environment. In addition, the composite mortar is subject to an expiration date and can be stored only under certain conditions. Further, the composite mortar must be stored and set separate from the anchor parts and special safety regulations must often be followed.

DE 102 16 897 A1 discloses a chemical-mechanical anchor element which has a sleeve part that is expandable by an expansion part and which, in addition, is anchored in the bore by means of a composite mortar. This anchor element can be partially loaded immediately after setting. After the composite mortar hardens, the load is introduced along the entire length of the bore wall.

This solution is disadvantageous in that the composite mortar is subject to an expiration date and can therefore be stored only under certain conditions. In addition, the composite mortar must also be stored and set separate from the anchor parts in this anchor element and special safety requirements must often be followed.

DE 11 98 037 A1 discloses an anchor element with pin-shaped fastening means for fastening in a concrete body. In order to form a cutout, a metal sleeve is inserted flush in the concrete body in which a sleeve part comprising polyamide is inserted. The pin-shaped fastening means are driven into the sleeve part and excess material of the sleeve part is displaced.

This solution is disadvantageous in that it is necessary to prepare a cutout that is specifically adapted to this anchor element. In addition, the sleeve part and the metal sleeve in this anchor element must be stored and set separate from the anchor parts. Since the fastening that is produced relies substantially only on a frictional engagement between the sleeve part and the metal sleeve or between the sleeve part and the anchor part, only small loads can be transmitted with this anchor element.

### SUMMARY OF THE INVENTION

It is the object of the present invention to provide an anchor element which overcomes the disadvantages mentioned above and, in particular, is simple to set and can be loaded immediately after setting. In addition, the load must be introduced substantially uniformly along the length of the bore.

This and other objects of the present invention, which will become apparent hereinafter are achieved according to the invention, by securing the sleeve part, which is made of a thermoplastic, to the anchor part.

The anchor part which is made of a rigid material, e.g., steel, is surrounded by the sleeve part made from the thermoplastic, so that the anchor element comprises an individual hybrid part and no parts of the anchor element need be stored or set separately. Further, the anchor element is substantially not subject to an expiration date and can accordingly be stored for a long time and without following special safety regulations.

The anchor element is fitted by rotating into a bore having a smaller diameter than the outer diameter of the anchor element and of the sleeve part. Because of the frictional heat that is generated, the thermoplastic of the sleeve part is heated until the material reaches a softened, melted or decomposed state, and excess material of the sleeve part is displaced or removed so that the sleeve part adapts ideally to the shape of the bore hole. Very small undercuts and irregularities in the bore can be used to form a positive-locking anchoring after the sleeve part hardens. The sleeve part is radially deformed additionally during the fitting process and, accordingly, an expansion force builds up. In addition, an adhesive bonding between the sleeve part and the bore wall is provided by suitable plastics. Insofar as the adhesion or the forces brought about by shrinkage processes, which usually occur during and after the plastics processing, between the anchor part and the sleeve part are sufficient for transmitting torque, and there is no need for a special construction of the anchor part or for the arrangement of driving means for transmitting torque.

The at least one expansion part for expanding the sleeve part is advantageously arranged at the end of the anchor part on the setting direction side of the anchor part and is constructed in such a way that the sleeve part expands under tensile loading, and the anchor element is therefore additionally anchored in the bore hole. This additionally reinforces the action of the expansion force that is already generated upon setting. The angle of taper of the expansion part measured relative to the longitudinal extension or relative to the longitudinal axis of the anchor part is advantageously between 5° and 40° and preferably between 10° and 20°. Particularly due to the acting expansion forces and adhesion, a plurality of anchoring parts contribute individually or in combination to a good introduction of load along the anchor element. In a variant, a plurality of expansion parts are arranged one behind the other at the anchor part as expansion cones so that the sleeve part is expanded in a plurality of areas when applying a tensile load to the anchor part.

Compared to conventional chemical anchor elements, it is possible to work with the anchor element according to the invention without drips even when fastening so-called overhead fittings in the ceiling area. Work safety is enhanced without taking special precautions and work can be performed neatly. Since there is no handling of chemical substances, there is a reduced risk of contamination and consequent discoloration in the area surrounding the bore hole as well as a reduced risk of incorrect setting. Further, it is not necessary to dispose of press-out devices and cartridges for the composite mortar. Compared to conventional expansion anchors or sleeve anchors, the load is introduced extensively homogeneously or extremely uniformly virtually over the entire length of the anchoring so that there are practically no local expansion forces, and it is therefore possible to realize small axial distances and edge distances. In addition, the anchor element according to the invention can be loaded immediately and there is no gap between the bore hole wall and the anchor part through which water or moisture can penetrate. Further, the anchor element according to the invention provides a fastening element which is economical to produce, requires a smaller setting depth for adequate anchoring than conventional expansion dowels or mechanical anchor elements, and can also be used in a cracked substrate.

The thermoplastic is preferably fiber-reinforced so that the mechanical properties, particularly the strength of the finished sleeve part, are improved over a thermoplastic without added fibers. For example, glass fibers or Kevlar® fibers are added to the thermoplastic. The thermoplastic can also be filled with a mineral, e.g., calcium carbonate, in order to improve its compressive strength in particular. The amount of the admixture contained in the thermoplastic is between 10 percent by weight and 50 percent by weight, preferably between 15 percent by weight an 40 percent by weight.

The thermoplastic is preferably polar so that an advantageous adhesive action is built up during the setting process particularly between the sleeve part and the bore hole wall and between the sleeve part and the anchor part. A thermoplastic which is distinguished particularly by its advantageous adhesive properties is, e.g., ethylene vinyl acetate (EVA).

The thermoplastic is preferably a polyamide having a melting temperature that ensures a residual carrying capacity in case of fire. In addition, polyamides are resistant to alkaline metals and have excellent strength and toughness, particularly with regard to cold impact strength.

Other examples of possible thermoplastics are polyoxymethylene (POM), polybutylene terephthalate (PBT), polypropylene, polyvinyl chloride, acrylic glass, polytetrafluoroethylene, polycarbonate, polyacetate, and high-pressure or low-pressure polyethylene, although this list is not exhaustive.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

FIG. 1 a cross-sectional view of an anchor element according to the present invention; and

FIG. 2 a cross-sectional view of the anchor element shown in FIG. 1 in the set state.

Identical parts are designated by identical reference numbers in the drawings.

### DETAILED DESCRIPTION OF THE PREFERRED EMBODIMENT

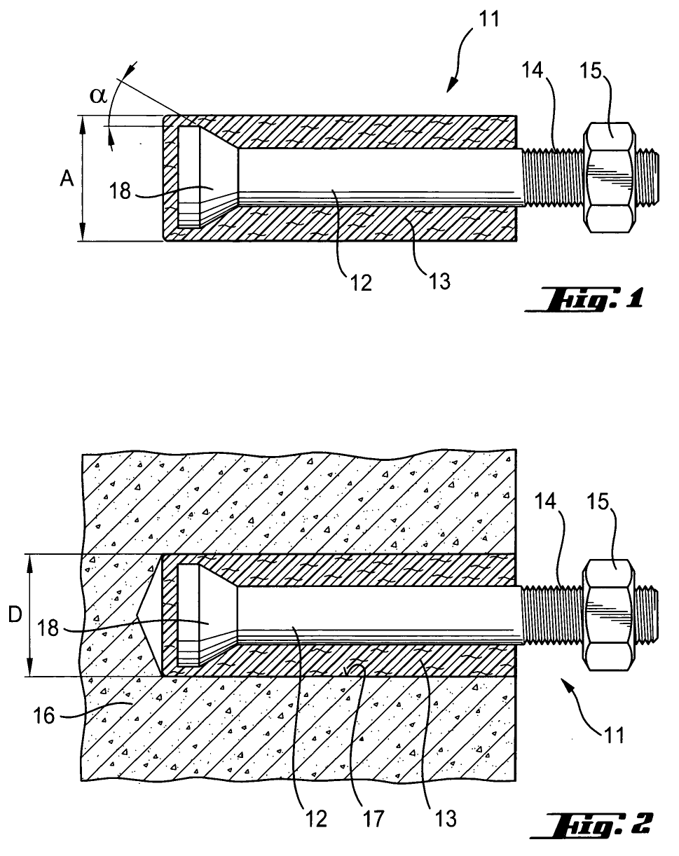

The anchor element 11 shown in FIGS. 1 and 2 has an anchor part 12 and a sleeve part 13 which is secured to the anchor part 12 and which is made of a thermoplastic, e.g., polyamide. At its end remote from its setting direction side, the anchor part 12 has load application means in the form of a thread 14 at which an object can be fastened to the substrate 16, e.g., by means of the nut 15, when the anchor element 11 is set in the bore hole 17. A cone-shaped expansion part 18 is formed at the setting direction end at the anchor part 12 for expanding the sleeve part 13. The angle of taper α of the expansion part 18 is 15° in this embodiment.

The outer diameter A of the sleeve part 13 is greater than the diameter D of the bore hole 17. The anchor element 11 is driven into the bore hole 17 by rotation via the thread 14 by a suitable device, not shown.

The thermoplastic is reinforced with glass fibers or has a mineral filling. Below are two examples for a glass fiber-reinforced thermoplastic:

### EXAMPLE 1

The sleeve part is made of a polyamide 6 (PA 6) with 25 percent by weight of glass fibers.

### EXAMPLE 2

The sleeve part is made of a polyamide 6.6 (PA 6.6) with 40 percent by weight of glass fibers.

The following is an example for a mineral-filled thermoplastic:

### EXAMPLE 3

The sleeve part is made of a polypropylene (PP) with 20 percent by weight of calcium carbonate.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. Anchor element, comprising an anchor part (12), a sleeve part (13) secured to the anchor part (12) and formed of a thermoplastic; and an expansion part (18) for expanding the sleeve part (13).

2. Anchor element according to claim 1, wherein the thermoplastic is fiber-reinforced.

3. Anchor element according to claim 1, wherein the thermoplastic is polar.

4. Anchor element according to claim 1, wherein the thermoplastic is a polyamide.
